(19) United States
(12) Patent Application Publication
(10) Pub. No.: US 2013/0237751 A1
(43) Pub. Date: Sep. 12, 2013

(54) Linear Motor and Handheld Unit

(71) Applicant: Taylor Lawrence Alexander, Campbell, CA (US)

(72) Inventor: Taylor Lawrence Alexander, Campbell, CA (US)

(73) Assignee: Taylor Lawrence Alexander, Campbell, CA (US)

(21) Appl. No.: 13/787,806

(22) Filed: Mar. 7, 2013

Related U.S. Application Data
(60) Provisional application No. 61/607,591, filed on Mar. 7, 2012.

(51) Int. Cl. A61H 23/02; H02P 25/06; A61H 19/00; H02K 33/00

(52) U.S. Cl. CPC A61H 23/0254; H02K 33/00; H02P 25/06; A61H 19/44
USPC 600/38; 310/12.24; 318/135

(57) ABSTRACT

A linear actuator is disclosed, that comprises a stator containing more than one coil, a mover containing more than one magnet, each said magnet separated from the adjacent magnet by a spacer, a power supply operable to provide current to said coils of said stator, at least one magnetic flux sensor, and a controller operable to control the relative motion between said stator and said mover, the controller comprising a module to measure the magnetic flux observed by the sensor and use that as feedback to control the motion of the mover relative to the stator. In a preferred embodiment, this linear actuator is used in a sexual appliance with user control over the linear actuator motion profiles.

### CROSS-REFERENCE TO RELATED APPLICATION

This application claims priority benefit of U.S. Provisional Patent Application No. 61/607,591 entitled “Linear Motor and Handheld Unit,” filed Mar. 7, 2012. The disclosure in that application is incorporated herein in its entirety.

### BACKGROUND AND SUMMARY

The present invention relates generally to linear motors, and more particularly, to programmable electro-magnetic sex toys using a linear motor.

Typical linear motor designs used in sex toys provide gross linear motion. Existing motorized sex toys have used inexpensive linear actuators, with a lack of precise control over actuator stroke, speed, acceleration, motion profile, or other parameters, which makes them less than ideal for use with people. Or else they integrate expensive precision actuator designs. These same limitations, among others, may limit the usefulness and range of applications of existing linear actuators or linear motors to the wide variety of low-cost applications where they are used. For the purposes of this application, the terms ‘linear motor’ and ‘linear actuator,’ should be understood to be interchangeable to the extent that they, or other similar devices, apply linear motion in response to electrical input.

There is currently no solution for a linear motor with precise control of the motion parameters of the mover, nor with control over different linear actuator motion control profiles. Or, to the extent that solutions may be found, typical actuators may be prohibitively expensive. Nor is there a solution for a handheld sex toy design that implements a precise linear motor with user control of the parameters. In particular, there is no linear-motion sex toy device that allows a user to control the device wirelessly—through a smartphone-type device, or remotely through the internet. The disclosed concepts address these needs, as well as others.

As a non-limiting example, one possible embodiment may be a handheld sex toy with a linear motor. The linear motor may include both a coil and a mover, where the mover reciprocates in the handheld housing. In this embodiment, the handheld coils may be essentially coils of wire displaced along the length of the housing, while the mover may be a series of magnets positioned along the length of the mover. The unit may further include a feedback controller with a sensor for sensing the motion of the mover. A controller may further be used to control the motion of the mover, and to accept input from the user to modify the motion of the mover.

### BRIEF DESCRIPTION OF THE DRAWINGS

FIG. 1A shows plan and cross-sectional views of the single-ended handheld unit design.

FIG. 1B shows isometric views of the single-ended handheld unit design.

FIG. 2A shows isometric views of the split-coil design.

FIG. 2B shows an exploded view of the split-coil design.

FIG. 3A shows a flux diagram of a simulation of the magnet and coil system.

FIG. 3B shows a cross-section of the magnet and coil system.

FIGS. 4A and 4B shows the variation in position sensor values along the mover position.

FIG. 5 shows the variation in position sensor values along the mover position, with the different sections delineated.

FIG. 6 shows the coil current versus displacement of the mover.

FIG. 7A shows plan and cross-sectional views of the curvilinear handheld unit design.

FIG. 7B shows an isometric view of the curvilinear handheld unit design.

FIGS. 8A and 8B show exploded views of the handheld unit design.

FIG. 9A shows plan and isometric views of the double-ended handheld unit design.

FIG. 9B shows a cross-sectional view of the double-ended handheld unit design.

FIG. 10 shows possible user input keypads on the handheld unit.

### DETAILED DESCRIPTION

While the exemplary embodiments illustrated herein may show various features, it will be understood that the different features disclosed herein can be combined variously to achieve the objectives of the present invention.

One objective of the present invention is to provide a linear motor with attributes that may include: precise motion control and/or relatively low cost, among other possible attributes. For the purposes of this disclosure, the terms “motor” and “actuator” may be used interchangeably. In addition, the term “linear” may mean at least some extent of linear motion, and may optionally include rotary motion in addition to linear motion. Or, alternatively, it may be curvilinear motion.

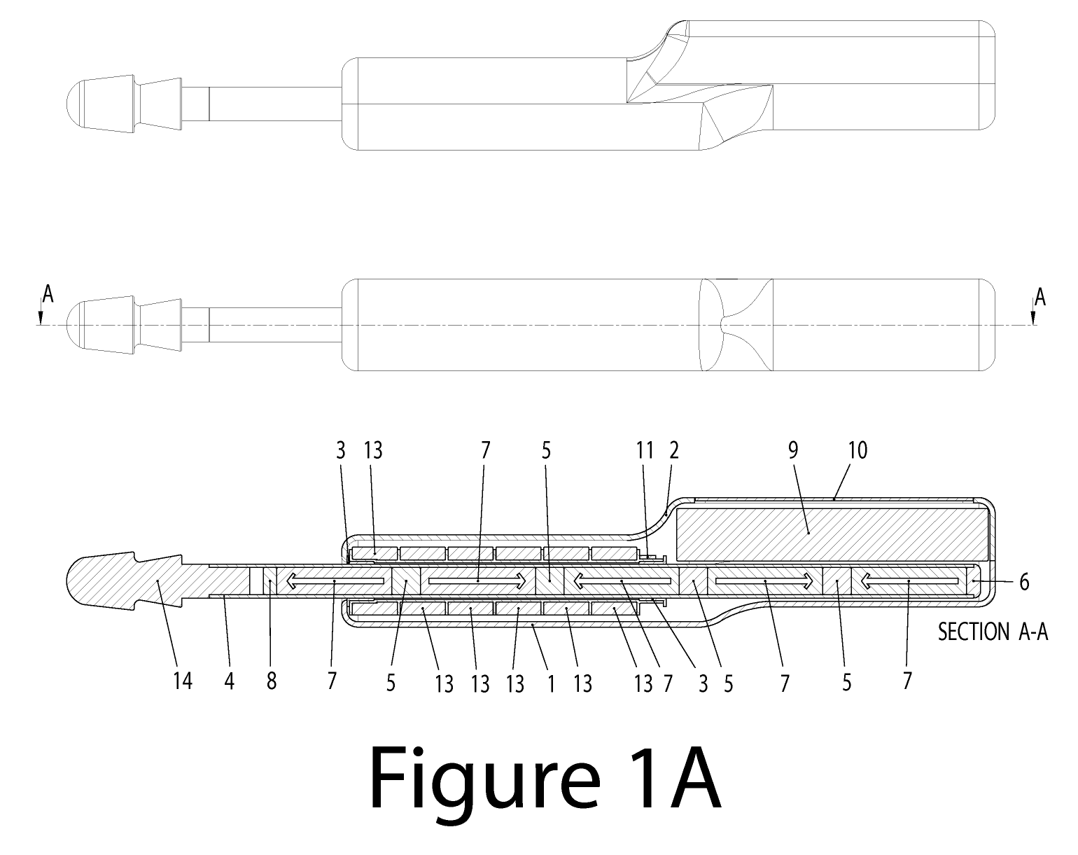

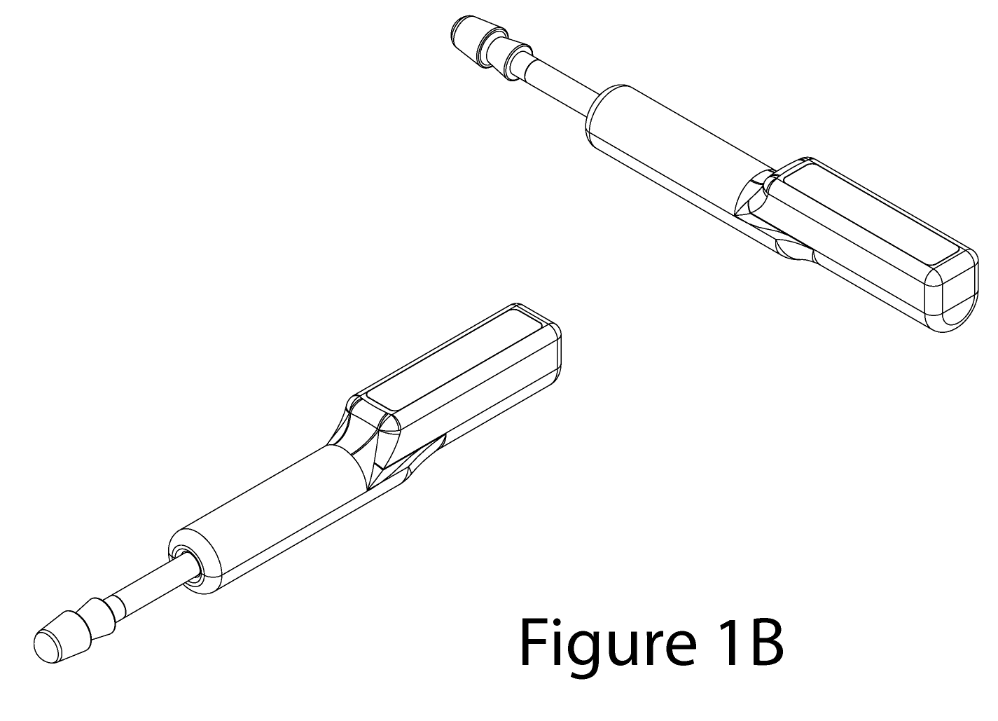

Turning to FIG. 1A, the linear motor may include at least a linear motor stator 13. The motor stator 13 may include at least one radial, round, or toroidal, wire coil, or a series of such coils 13, separated by spacers. Note that the wire coils can be wound around any axis of the radial stator, for different results—toroidally, around the circumference, or around the radius. The spacers may be a variety of different conductive or non-conductive materials. The motor mover can be a longitudinal member that moves inside the cylindrical stator 13. The motor mover can include a housing tube 4, which contains at least one magnet 7 inside of the housing tube 4. Note that the arrows on the magnets in FIG. 1A indicate one possible orientation of polarity of the magnets. If more than one magnet 7 is used, they may be separated from each other by spacers 5. These spacers can be made of a variety of materials, including various plastics. In an alternate embodiment, iron may be used within the housing to augment the coils' magnetic field for increased for capacity.

In this embodiment, the linear motor consists of two main parts, a mover and a stator. The stator may be a series of cylindrical electrical coils butted up end to end to form a long cylinder of separate coils, and the mover may be a tube of permanent magnets that slides inside the cylinder of coils. For the purposes of this application, “cylindrical” may be a hollow cylindrical shell, or a cylinder with an axial hole. The magnets may be hidden or exposed. Note that the “mover” may be fixed, if the stator has some way of getting power while moving, such as a flexible cable. Typically though, the stator is fixed and the mover is not. The mover slides inside of the coil assembly, and electrical current applied to the stator creates a magnetic field that reacts against the magnets inside of the magnet tube. The mover may optionally ride on bearings 3, to assist motion. The magnetic field causes the mover to slide one way or the other through the coil assembly. One embodiment of the present invention uses no brushes, making it a brushless DC linear motor. It is important to note that the terms “stator” and “mover” are reversible within this concept. That is, the coils could be in the mover, and passing through radial, round, or toroidal magnets in the stator, or vice versa.

The spacing and orientations of the magnets may vary based on the design. For example, a series of single magnets, all oriented north-south could be used. Or, two smaller magnets could be placed together in the same orientation, followed by a spacer and two additional magnets in the opposite orientation. And so on. Similarly, the coil orientations can be varied along the length of the stator. In a preferred embodiment, a linear motor may have 3 sets of coils. Each coil can have two ends, with one end of each coil is connected, so there are only 3 wires from the stator, and from the linear motor as a whole. In an alternative embodiment, each of the coils could be wired separately, and separately controlled by the controller. This embodiment may require 6 Half-Bridge motor drivers, instead of the normal 3 half H bridges more commonly used to control brushless motors, but would give more control over the current flow through the wires of each individual coil—and thus more control over the motion of the motor and of the mover.

Typically, all the coils are wired so that current flows in the same direction, and all the magnets are facing the same direction. However, it may be desirable to position the magnets in alternate magnetic orientations, with the coils in groups of 3 that alternate the direction that current flows. Various magnet orientations and coil current flows can be combined to achieve different motor goals, including: more precise motion control or increased motor force. In another embodiment, it may be possible to reverse the design of the motor, such that the magnets are in the housing of the motor, and the coils are in the mover. In yet another embodiment, it may be desirable to reverse the normal direction of current flows through at least one of the various coils while the motor is operating.

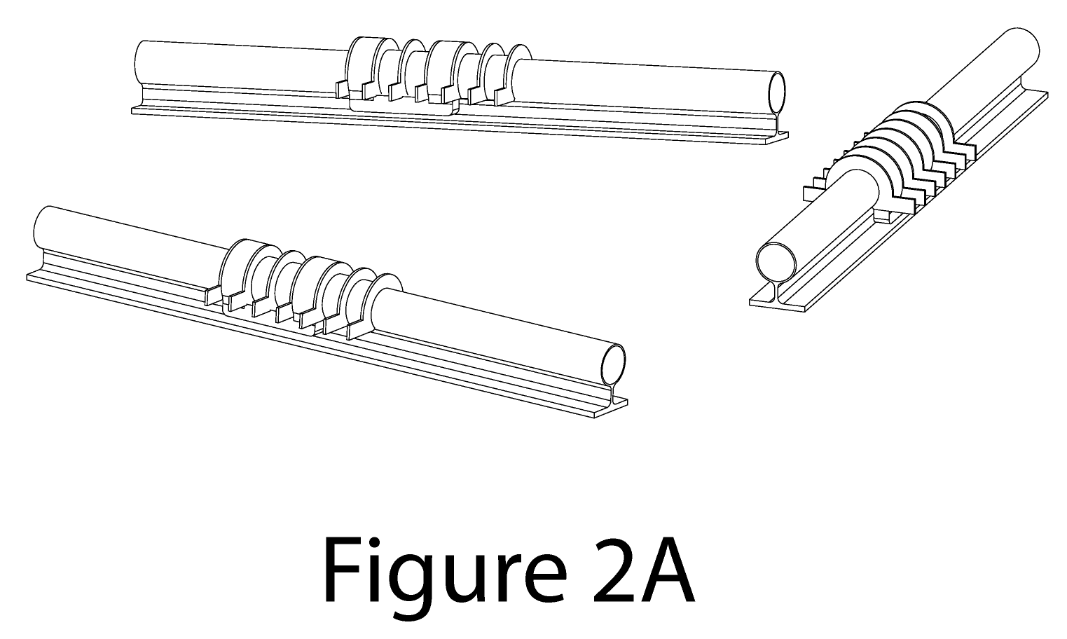

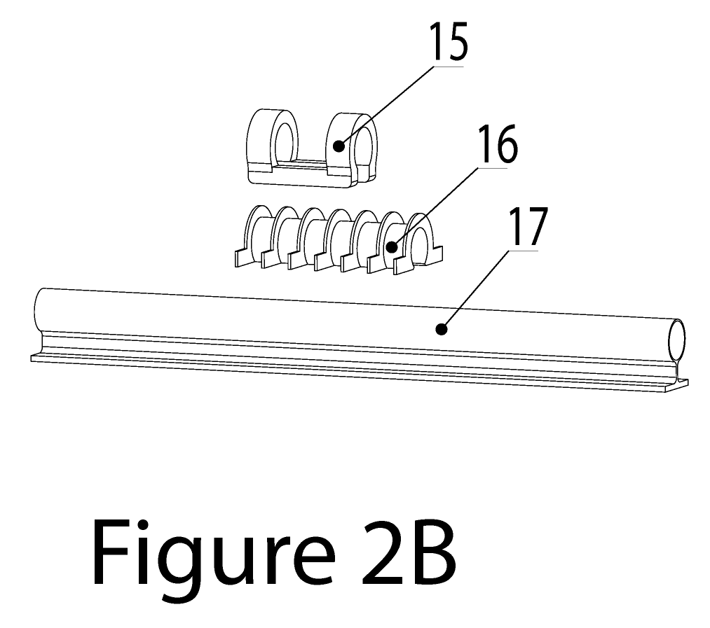

In another embodiment of the linear motor, a “split-shaft” design may be used to allow even more applications. One possible embodiment of this design is shown in FIGS. 2A and 2B. In this design, the stator 15 and 16 may be a split coil, i.e. a coil that is not a complete circle. For example, the stator 15 and 16 may be only 300 degrees, with a 60 degree slot down one side of the stator. The mover 17 may then include not only a cylindrical section with internal magnet, but also a structure that extends through the slot in the stator. This configuration may open up a variety of additional applications, including those where the mover may have a structure on its side, where features may be mounted to the mover, or where the mover may be mounted to a structure. It may also be used to prevent bending of a long mover 17. One feature that makes this design possible is that the adjacent coils can be wound in reverse orientations. If one is wound clockwise, the wire can reach the next coil laterally—without crossing the open slot—by winding the next coil counterclockwise.

In one possible motor configuration, the electrical current can alternate direction every 3 coils. These may alternate along with the polarity of the corresponding magnets. This might allow coils to be wound in a split configuration. The design may wrap the coil around one section about 270 degrees, then go across 3 coils, wind back on that one 270 degrees, come back to the first coil, and repeat, creating a coil 15 that is somewhat “saddle” shaped.

Turning to FIGS. 2A and 2B, these figures show one possible embodiment of the split shaft design, with a “saddle” magnet design. The tubular linear motor consists of a coil assembly (stator) and a tube of magnets (mover 17) Typically, the tube moves and the coils are fixed. However, is possible to reverse that arrangement. The tube can be fixed, and wires with some slack can be run to the coils, allowing the coil assembly to move around on the fixed rod. This is actually simpler in many ways, and allows easily mounting something on top of the moving part. This design works well for short distances, and the tube can fully support the coil assembly in many cases. However, with very long distances, the tube will begin to sag under its weight, or the weight of whatever it is supporting.

If this were not a linear motor, but a simple linear bearing, the solution to supporting long rods is simply to split the bearing and add a support member to the rod. This is relatively straightforward with linear bearings, but impossible with traditional tubular linear motors, because they require a continuous circular coil to operate; one cannot easily split the coil to allow a support member. However, it is possible with the present invention to split the coils so that they ride on a support rod. More specifically, it may be possible to split the coil spool or coil bobbin on the bottom to accommodate a rail. In addition, it is further possible to reverse every other magnet, and then reverse the current in every other coil for a given phase and get more force. This has a side effect of allowing a split motor design as well.

In FIG. 2B, the coil section 15 represents one phase (A) of the coil assembly. In one preferred embodiment, it is not one solid piece, but a winding of one continuous strand of magnet wire, wound over and back many times. In that embodiment, it may also be the case that phase B and C are wired in a similar way after this.

One possible result of this would be 3 oddly-shaped coils, but they would have a valuable property: current flowing one direction in the front of the A coil would flow in the reverse direction in the other part of the coil. In this embodiment, the coil is split. This could allow for a magnet tube with a support rod extending from it, as shown in the FIGS. 2A and 2B.

Using this split-coil design, this tube can now be of any length. One could wind 3 rectangular coils and then lay them over this assembly to more easily get the windings right. It may be possible with this design to either use bearings to ride on the rod, or to eliminate the bearings. Since the system may operate with every other magnet reversed, every other set of 3 coils can get reversed as well. This means that a saddle shaped coil, where current would flow one direction in the front, would have current flowing in the other direction in the back. Since the standard design already normally uses coils where every 3^{rd} coil is reversed, the natural reversal of the saddle arrangement works in favor of the split coil design.

A feedback control system is used to control the position and motion of the mover. In this system, a position sensor measures the position of the tube and reports the position of the tube to the main drive and control electronics. Those control electronics control the current that is driven through the coils, creating a feedback system that allows precise control of the position of the tube. A plastic, or other suitable material, linear bearing at each end of the coil assembly supports the magnet tube while allowing it to slide freely. A variety of different position sensors may be used with this invention, including contact and non-contact position sensors.

In a preferred embodiment, the position sensor can be at least one magnetic flux sensor, which would sense the magnetic flux at a position on the mover to determine the location of the mover in the stator. The flux sensor may be placed at one end of the mover, or at another position along the length of the mover. There may also be more than one flux sensor. Alternatively, a flux sensor could be combined with another type of sensor.

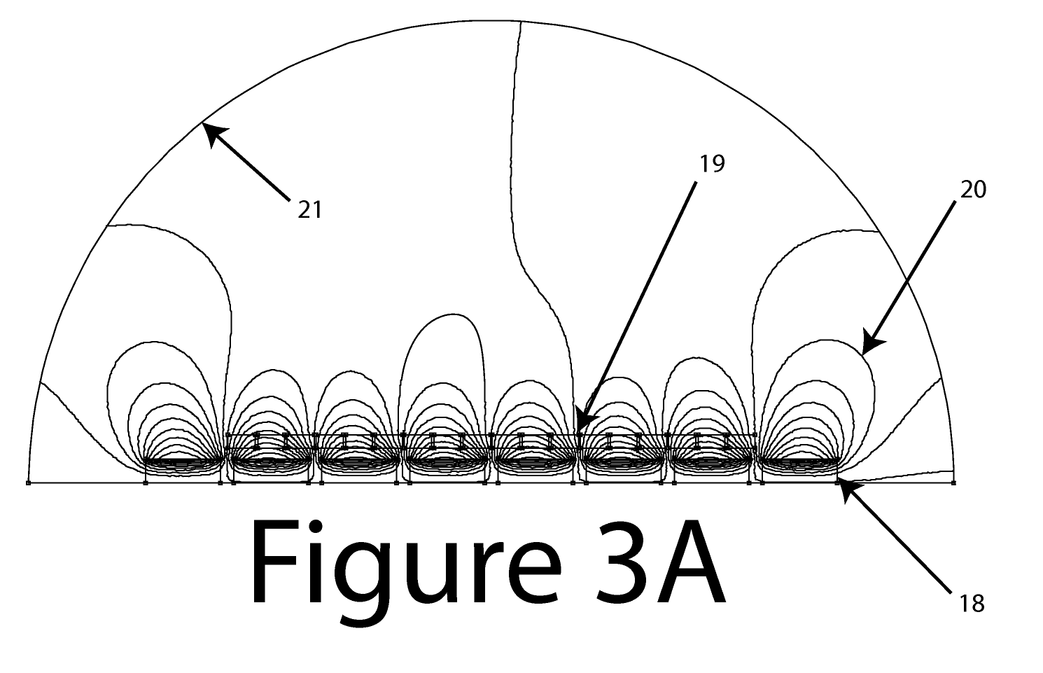

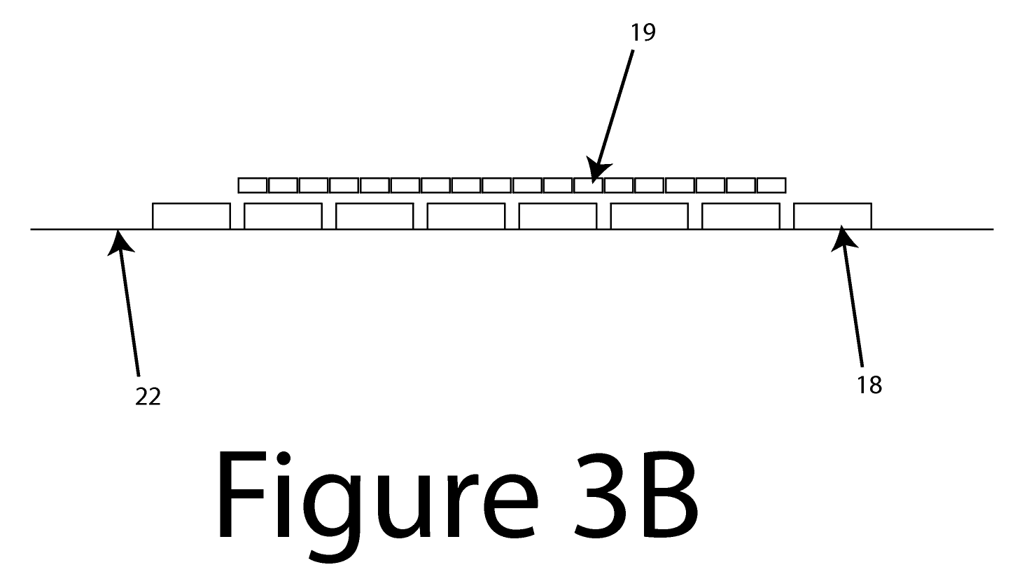

Turning to FIG. 3A, this figure shows a simulation of the magnetic flux distribution 20 along the stator coils 19, showing that the flux changes along the length of the mover 18. Additionally, FIG. 3B shows the simulation before the magnetic flux distribution, to clearly show the mover magnets 18 and stator coils 19, with the axis of symmetry of the simulation shown as 22. As a flux sensor mounted to the mover moves along the length of the stator, the exact position of the mover within the stator can be determined from the flux magnitude. This may allow for precise control of the mover position and motion. In an embodiment using only one or two flux sensors, it may only be possible to determine the mover position relative to certain magnets. However, it may be possible to program the software to determine the beginning mover position at startup of the device, to more accurately determine subsequent positions. Or, other embodiments may be use additional sensors for more precise control.

Using feedback control of the mover position, a variety of position and motion parameters of the linear motor can be controlled by the control system, including: mover stroke, mover speed, and mover acceleration. In addition, various profiles are possible, including nonlinear motion profiles, such as sine wave motion. With the precise control of this system, it may also be possible to have smaller order motion, within the larger bulk motion. For example, one embodiment may vibrate the mover back and forth during its stroke inwards or outwards.

The software that controls the motor position (and possibly speed and acceleration, jerk, snap, vibration, rotation, or any other pertinent, controllable motion parameters, if implemented) has several distinct steps. For the purposes of this application, the control of the mover motion, or motor speed or acceleration, may generally refer to any one of the types of different motion listed above, as well as any other controllable parameters understood in the art. These may be referred to as motor/mover “trajectory” in this application. As a first step, it determines the desired position, speed and acceleration. There are several ways of generating motion profiles, or trajectory data. In its simplest form, a software timer could simply toggle the desired position between two values. For example, it could cycle between 1 inch extension and 4 inch extension, back and forth, at, for example, 1 Hz intervals. This would effectively command the rod to move in a “square wave” pattern. More complex ways of generating motion can be used, however. To move the rod through a sine wave pattern, a timer would need to run more often, iterating through locations on a sine wave. For example, each time the software timer “ticked,” it could increment the sine wave by 1 degree. The first time it ticked, the position would be changed to sin(0 degrees), then sin(1 degree), etc. The value of that location on the sine wave could be multiplied by some constant scaling factor, and the result would determine the desired position of the rod. The slope of the line at that position would determine the desired velocity. Acceleration may or may not be controlled—but one could, for example, limit the maximum acceleration, to prevent “jerky” motion. Control of acceleration might be abstracted to the user as a “smoothness” parameter, which may relate directly to acceleration control, or optionally control several parameters that result in smooth motion.

More complex motion profiles could be described in a variety of ways. A mathematical formula is one option, or simply a series of data points (speed, position, acceleration) could be stored in a lookup table. Vibration could be described either by using many data points, or it could be added as more parameters in the data table, which could be simpler. In that case, a motion profile could be described as a series of data points that include: speed, position, acceleration (or a max allowed acceleration), vibration frequency, and vibration magnitude. The user could use their input panel or other interface to adjust the speed at which the device steps through the data table—by adjusting cycle time, scaling, and perhaps other parameters like max acceleration, max speed, max force, etc. The final calculated desired position speed and acceleration would be combined from data tables, and the user adjusted scaling factors/limits.

Having determined the desired trajectory, the software determines the actual position, speed, and acceleration (or trajectory). Position is directly measured using possibly two magnetic field sensors. Speed and acceleration (and possibly jerk and snap) are calculated from position over time. The magnetic field sensors return a repeating wave pattern that can be used to calculate the rod's position within one phase of the magnets (a magnet-spacer-magnet-spacer set). That value will repeat when moving to a new phase, so the processor can keep track of which phase it is in. For example, if one phase is 2 inches long, the position calculation will only ever return a position from 0-2 inches. If the rod's stroke is 6 inches, there are 3 different phases the rod could be in. That is, if the sensor data says it is at a 0.75 inch offset, it could actually be at 0.75 inches, 2.75 inches, or 4.75 inches. To solve this, the unit “zeroes” itself at startup—running all the way inward until motion stops (or an end stop sensor could be used). Then, if for example the rod is moving outward, position data might come back as 1.80″, 1.85″, 1.90″, 1.95″, 2.00″, 0.05″, 0.10″. Note that the last two values (shown in bold) indicate it has “rolled over” to a new phase. The software simply takes the raw positional data, and adds or subtracts a phase (2″ in this example) as necessary when rollover occurs, to determine actual position. It is also possible to install additional sensors that detect which phase the rod is in using some other means—as a non-limiting example, infrared sensors inside the housing at 2″ intervals (using the 2″ phase example) could determine which phase the rod is in. This would eliminate the need for zeroing.

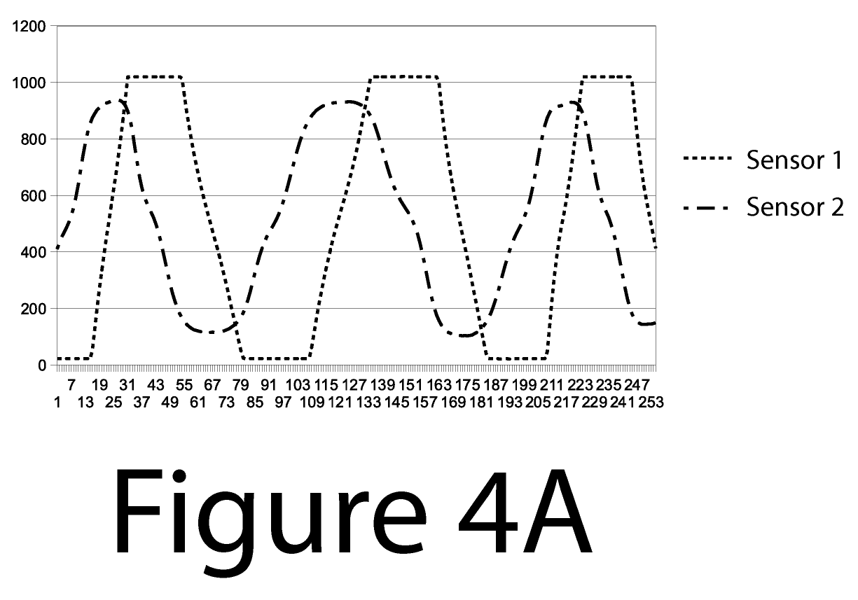

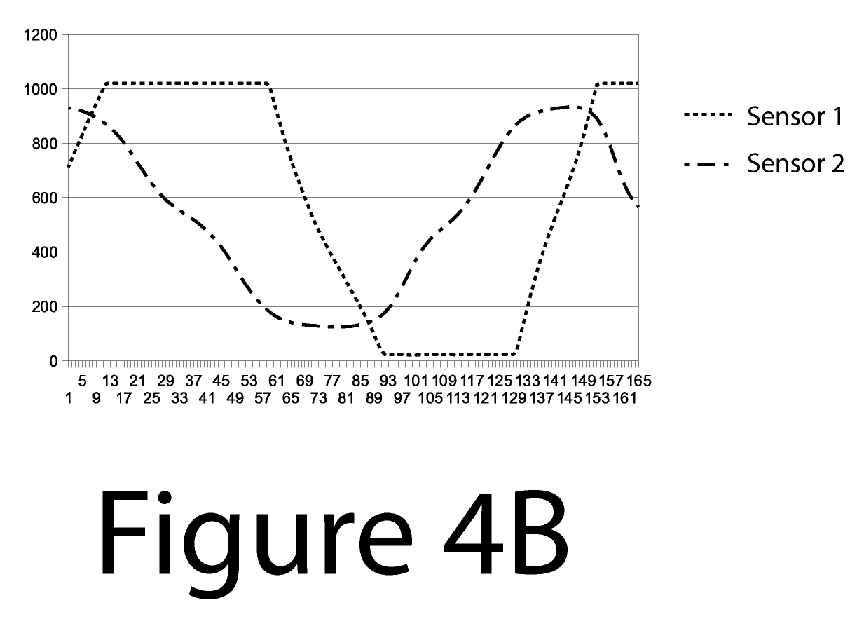

FIG. 4A describes how the position sensor varies with position over the length of the mover as the mover moves axially relative to the position sensor. This figure shows actual sensor data taken from a moving rod through several phases. The vertical axis represents sensor voltage (in this case, a number from 0-1023) and the horizontal axis represents position. The data shows approximately 3 complete phases of the sensor data. The spacing between phases is not even on this plot, as the data capture was a plot of sensor data versus time of a moving rod, and the rod was not moving at a constant velocity, but a plot of sensor data versus rod position would look similar, with more evenly spaced cycles. For the purposes of this disclosure, it will describe the graph as if it were an evenly spaced plot of sensor data versus position.

FIG. 4B shows a single phase taken from the above data. Note that there are basically 4 sections: Sensor 1 high, Sensor 2 sloped; Sensor 2 low, Sensor 1 sloped; Sensor 1 low, Sensor 2 sloped; and Sensor 2 high, Sensor 1 sloped—where Sensor 1 and Sensor 2 represent the voltages from the two magnetic sensors (one axial and one radial). So, at any time, one sensor is near its maximum or minimum value and the other sensor is roughly linear.

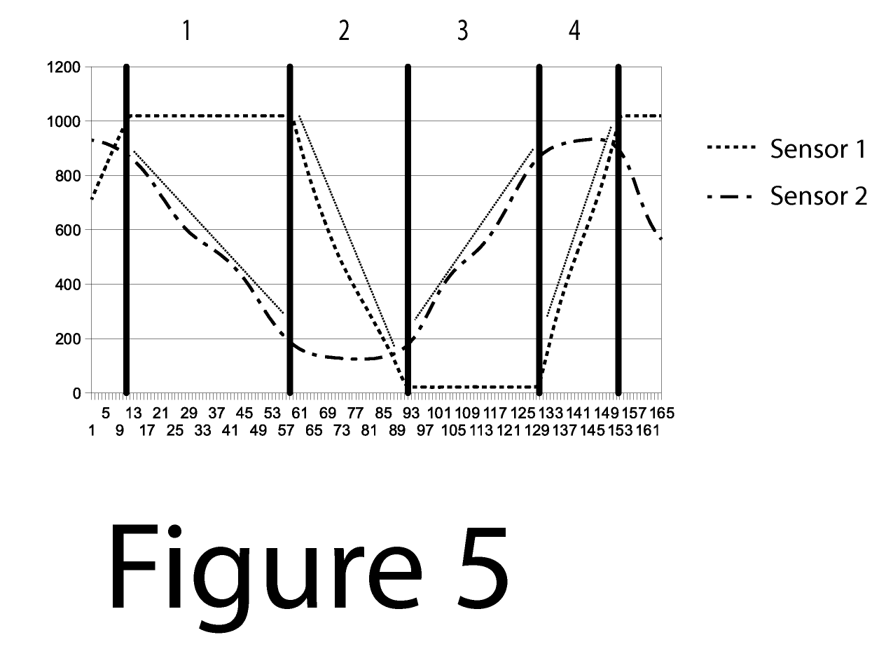

FIG. 5 shows the same image, but with a few lines and markers drawn on it. The thick black vertical lines represent the division between sections. Since the Sensor 1 data is more linear, the software can try to use it more often. That means that sections are delineated by that sensor entering or leaving its minimum or maximum value. Light dashed lines are shown above the sensor data in each section to indicate how the sensor data can be treated as a series of line segments, which then represent the linearized representation of each sensor's data for a given section. The system can use the data—from the flux sensor that creates sloped data—from each section to generate an equation for a line. Then the software determines which section it is in by determining if either sensor is near its minimum or maximum value. For example, if the system detects the following two sensor values: Sensor 1: 10, Sensor 2: 600. If the system knows that 10 (for example) is the minimum for Sensor 1, then Sensor 1 is at its minimum and the system must be in section 3 (denoted by numerals above each section of the plot). Then the controller algorithm may use the equation for the line for Sensor 2 from section 3, and put in a value of 600 for the sensor voltage. The equation takes the sensor voltage and returns the position within the phase. So in this example, the Sensor 2 has a value of 600, and the system is in section 3. Looking at section 3 of FIG. 5, it is easy to see that an equation for the green line in that section, when given an input value of 600 (represented by the vertical axis on FIG. 5), would return a value of roughly 109 or 110 (shown on the horizontal axis of FIG. 5). That means that given our two sensor values of Sensor 1: 10 and Sensor 2: 600, the rod in the motor must be at a position of 110 units from the beginning of the last phase. Looking at where the leftmost and rightmost vertical thick black lines intersect with the horizontal axis, one can see that one total phase (4 sections) is about 140 of the arbitrary units that the horizontal axis represents.

In another embodiment, it may be possible to simply have a few sensors oriented the same way (Sensor 1), spaced apart. Thereby, when one sensor is over a magnet section that maxes out the sensor, one of the adjacent sensors will still be in the linear section. This is possible because the data shown by Sensor 1 is relatively linear.

As another example, if the system is 80/140 units through the phase, and example a phase is still 2″, then the system is 80/140*2″ or 1.143″ from the beginning of the phase. If the system had just zeroed, the system would know that our actual calculated position was in fact 1.143″. If the system had “rolled over” one phase already, it would be at 2″+1.143″, or 3.143″. All numbers in this disclosure are just for illustrative purposes, and are not intended to be limiting. In a variation on this technique, the curves could be fitted or described with non-linear representations with non-linear regression, or a similar technique.

There are other optional ways to find the position data. A lookup table can be generated that stores pairs of sensor data at regular increments (as a non-limiting example, Axial and Radial sensor data at 0.00″, 0.05″, 0.10″ . . . etc.). Then to determine location within a phase, the controller may iterate through the table and compare the real sensor data to each pair of values in the lookup table, using the least squares method to find the closest match. That is, for each set of values in the table, find the difference between the measured Axial value and the one from the current set in the table, and square that number, then do the same with the Radial sensor values. The controller can then sum those squares. The controller would now have the sum of the squares of the error between the measured values and this set of values. If the controller performs that for each set of values in the table, the set that gives the smallest number is the closest pair of values to the measured values. That method may be more computationally intensive, and it may be less accurate. The same method as above could be used similarly for speed or acceleration control. The lookup table may be used in conjunction with interpolation techniques to determine position to a higher resolution than the table increments.

As a third step, the software may calculate the required force vector (magnitude and direction) to correct the actual position, speed, and acceleration to match the desired parameters. In this case, the rod has a certain direction, speed, and acceleration that is desired, and associated real world values for those parameters. Using a PID or similar controller, the system determines the desired position, then generates a scaling factor based on how far from the setpoint the system is and how it is moving towards or away from it. That would be the force it needs to exert on the rod, if it did not also have speed control. If the system also has speed control, it would look at the current speed and acceleration, and may alter the desired force value if necessary. Optionally, the systems may also limit the acceleration, so even if the speed is below the setpoint, or if it is accelerating too quickly, it may scale back the force value. At the end of this step, the system has a force value that is a number from −1 to 1 that represents how hard it will try to push the rod and in what direction.

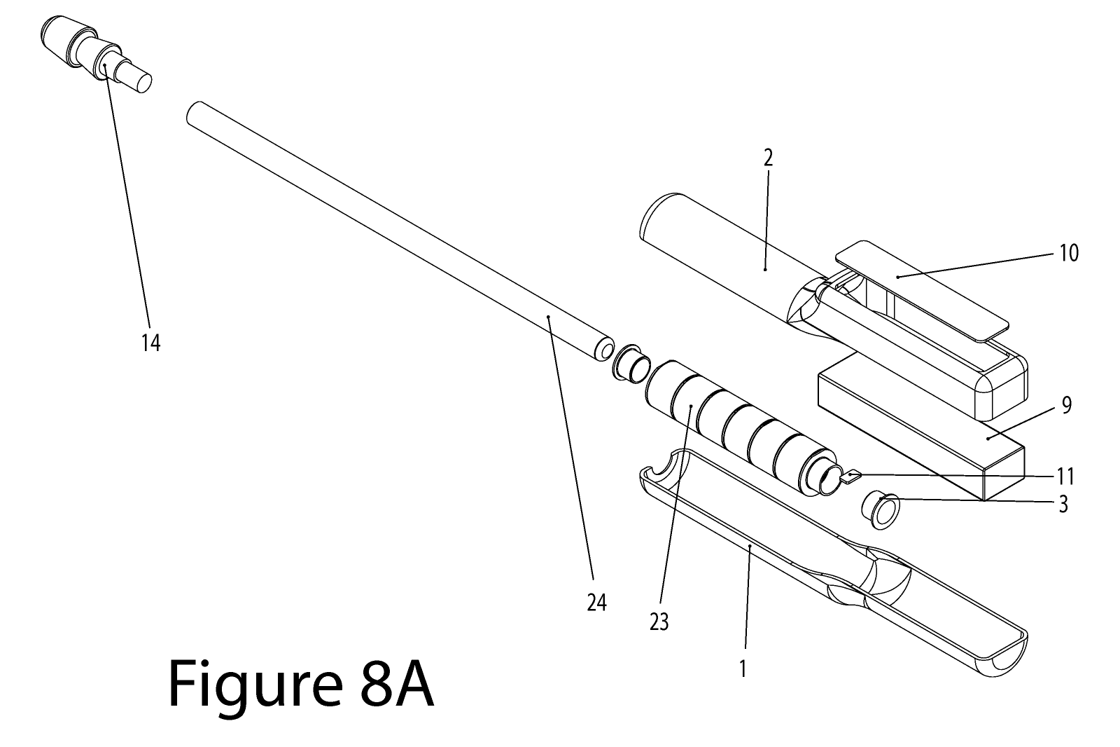

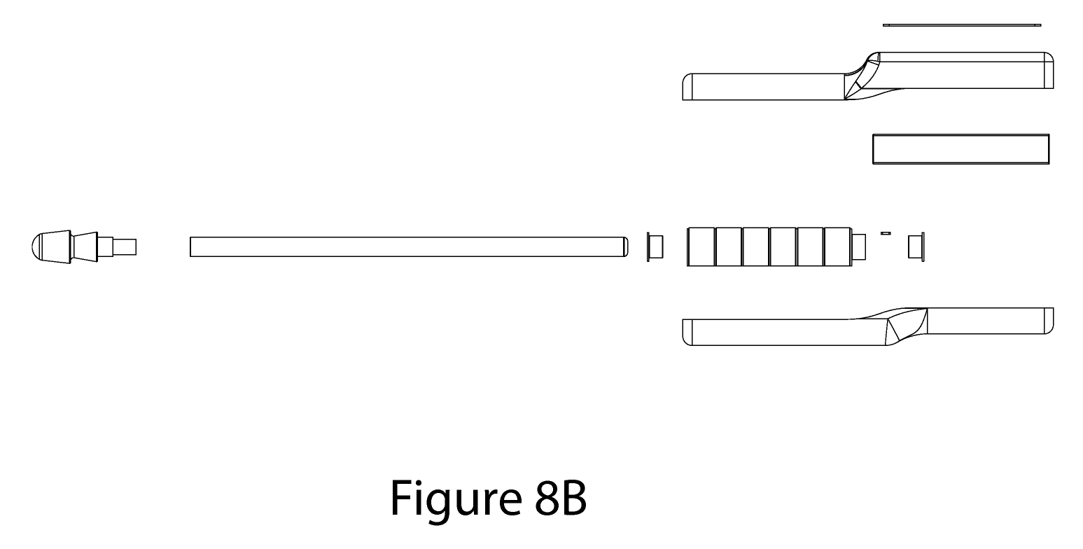

As a fourth control step, the software will set the current in each of the 3 coil phases to create the desired force on the mover. Once it has determined how hard it can push the mover, and in what direction, the software can set the current in the coils to accomplish this. For a given rod position, the ratio of the currents in the coils will generally be fixed, and the actual current will be scaled based on how hard it pushes. As the rod moves, the necessary current follows a sine wave that repeats with each phase. Each of the 3 phases follows sine waves that are 60 degrees out of phase from the one before it. This is shown in FIG. 8. Alternatively, the waves could be other shapes—such as trapezoidal.

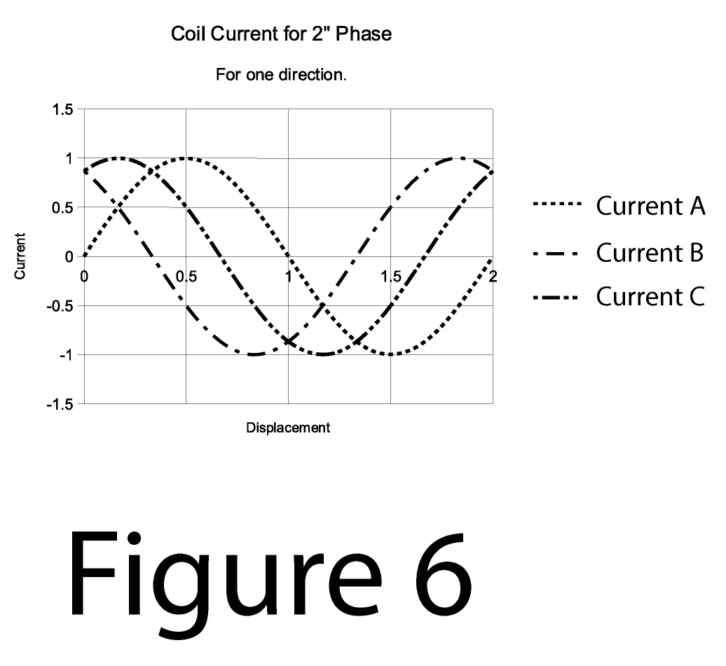

FIG. 6 shows the necessary current multiplier for each coil phase to push the mover in one direction, again based on a 2″ phase distance. FIG. 6 shows phase A, B, and C, as well as the “total phase distance.” A 2″ phase distance means 2 inches for six coils total—A-B-C-A′-B′-C′. So, each coil would be 0.333″ wide in that case. All the examples above that mention a 2″ phase refer to this configuration. For example, if the rod is currently offset 1.5″ from the beginning of a 2″ phase, one may want to push it “forward” with 50% of the total force capability. That is, the value from the third control step came out to 0.5. For this example, also assume the motor can draw a total of 10 amps per coil. At 1.5″ (the horizontal axis in the chart) it can be seen that coils A, B, and C have values of −1, −0.5, 0.5. If one multiplies that value times 10 amps maximum current, as an example, one would get the maximum force possible on the rod. However, step 3 gave a force scaling factor of 0.5, so that must be factored in. In this case, one may set the currents in coil A to −1*(10 Amps)*0.5=−5 Amps. In that case, B and C would be −2.5 A and 2.5 A, respectively. If step 3 had given a negative number, that would mean it would be desirable to push the rod “backwards.” Ideally, the steps above would occur at approximately several hundred (500, 1000, or more) times a second to ensure smooth operation.

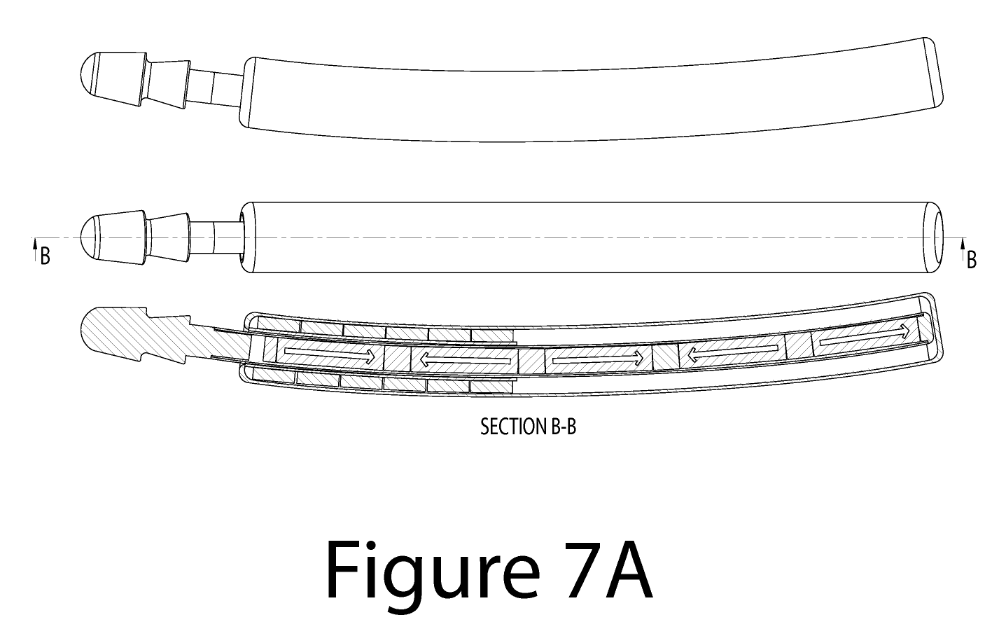

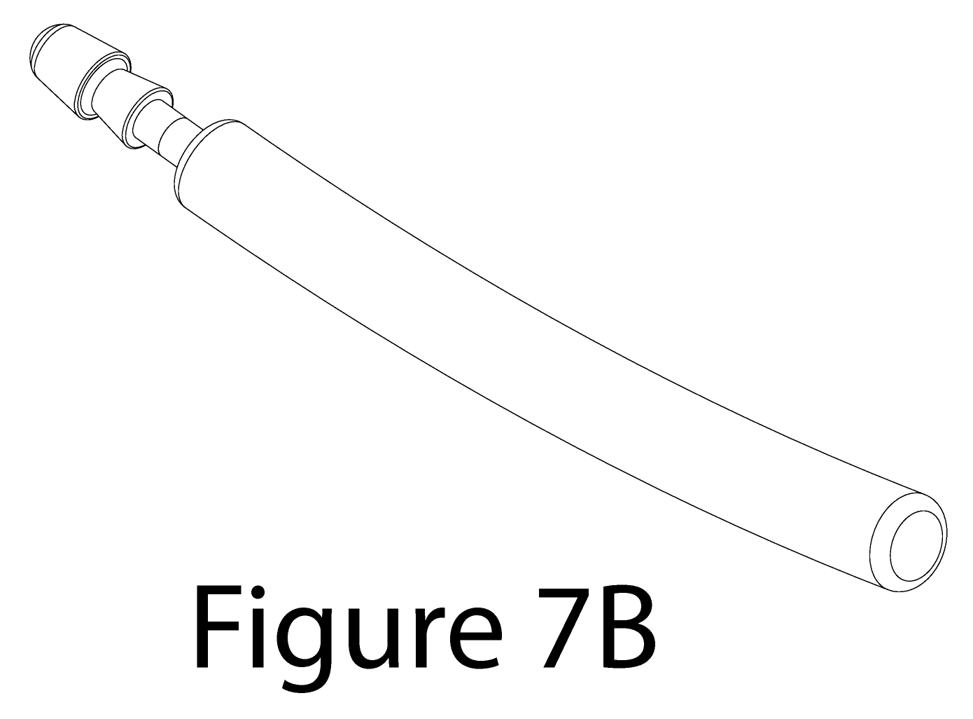

Turning to FIGS. 7A and 7B, the stator and mover could be designed in a curved configuration such that the linear motor actually produced curvilinear motion. There are a variety of ways to accomplish this embodiment. One way is to design two rigid pieces, where the stator and the mover have the same radius of curvature. In another embodiment, at least one of the two may be flexible, such that its radius conforms to the other as it moves. For example, the stator may be rigid with a fixed radius of curvature, while the mover has magnets fixed to a flexible rod, such that it curves as it retracts into the stator. Or, the mover could be curved, then straighten as it retracts into the rigid stator.

Turning to another embodiment, it may be desirable to combine rotary motion of the mover along with linear motion. One possible way to accomplish this is to attach a rotary actuator between the mover and the stator in the linear motor. In another embodiment, the same brushless design of the linear motor could be used for the rotary design. That is, permanent magnets may be positioned radially around the periphery of the mover. Corresponding to these magnets could be coils positioned radially around the periphery of the stator. Thus, relative rotary motion could be created between the rotary stator and the mover radial magnets. Another embodiment may feature special bearings that allow linear motion but inhibit rotary motion (with respect to the bearing). A normal rotary motor could be attached to said bearing such that rotating the bearing rotates the mover.

Turning now to FIGS. 8A and 8B, these figures illustrate the integration of a linear motor design into a programmable electro-magnetic sex toy. The linear motor could be similar to the design described above, or another type of linear motor or actuator. In one embodiment, a linear motor, as described above, is integrated into a housing, comprised of housing halves 1 and 2. The housing may include a battery 9 and PCB 10. The PCB 10 may include not only the motor control system, but also user input capabilities, for control of the motion parameters. The distal end of the mover 24 may include an adapter 14 for the attachment of a specific sex toy device. The mover, reciprocating forwards and backwards, provides the motion desired for an electro-magnetic sex toy. The housing on this embodiment is designed to be handheld. However, in another embodiment, the housing could be a stationary unit, or designed to mount into a stationary unit. The device may include some kind of mounting points so that it can either be used handheld, or mounted to a rigid body (like a bed post or desk). In another variation, the unit could be powered via a plug-in wire via a connector on the surface of the housing, versus a battery internal to the housing.

Typically, the device will be “single ended,” with one mover end exposed. There will be one opening in the device that allows the tube to slide inside of the coil assembly, where it will side until it passes through the coil assembly. An optional feature in the motor design is to provide a travel stop to prevent extreme outward or inward motion of the mover.

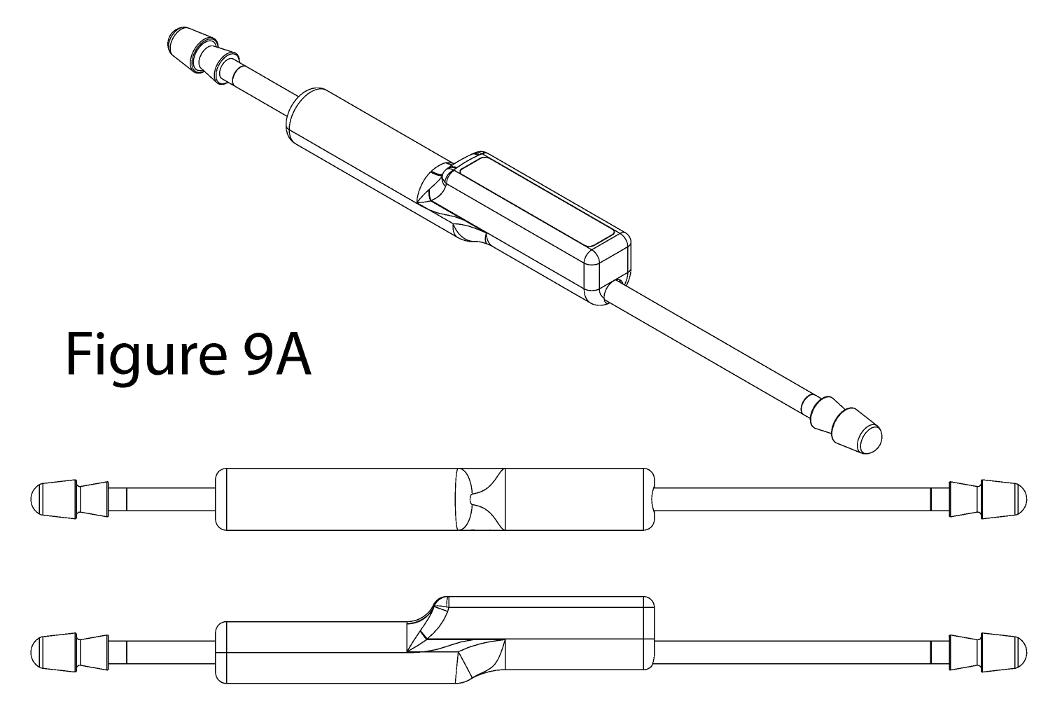

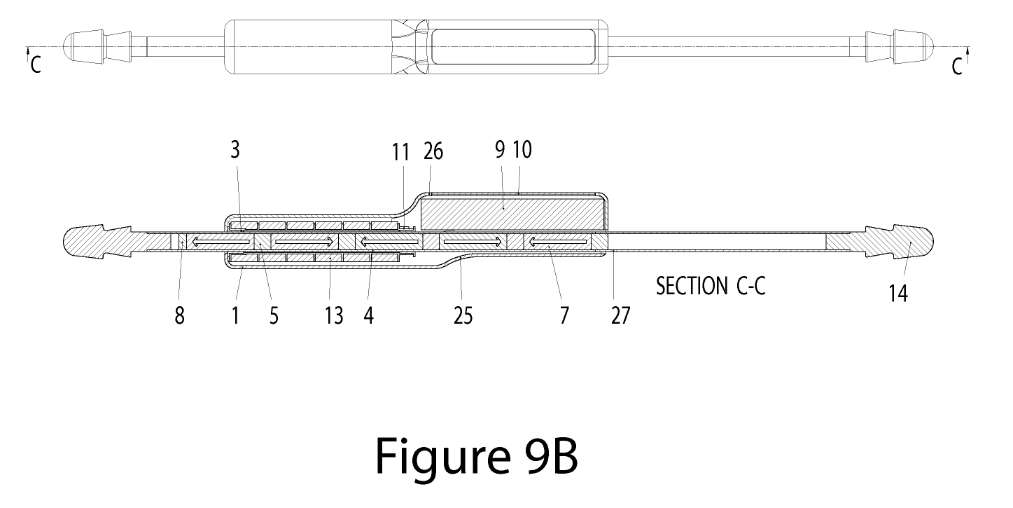

In another embodiment, it is also possible to create a double-ended device, where a slightly longer tube, or a tube extension 27, is used, and the housing 25 & 26 has two openings—one on each side. A toy, dildo, or any other type of implement designed to accommodate anatomical comfort could be attached to both ends at once, allowing the machine to be enjoyed by two people at the same time. The device may support a broad variety of attachments, with some way of easily switching them out with or without tools, which is true of the single-ended version, as well. This embodiment is shown in FIGS. 9A and 9B.

In the preferred embodiment, the user interface would allow handheld control of the motor motion parameters via buttons, touch screen input, or other input means known in the art. The input area may include LED indicators, an LCD screen, or other visual indicators. Audible indicators may also be used. The user input may control individual parameters, such as stroke length, speed, acceleration, or motion profile and store them in internal memory in the motor control system. In another embodiment, the user input may simply switch between different “profiles,” which each have different parameter settings. For example, Profile 1 may be a slow, short stroke, while Profile 2 may be a fast sinusoidal stroke. Another profile may have fast extension of the mover, with slow retraction of the mover. Another favorite profile may vary stroke lengths over time. Another may include vibration of the mover. And so on.

In another possible embodiment, the PCB board inside the handheld housing may include a plug to attach a wire. As a non-limiting example, a micro-USB plug on the surface of the housing could be used to connect the sex toy to a computer. The computer interface could then be used to modify the motion parameters, or the preset profiles in the memory of the PCB.

A variation of the interface programming feature would integrate wireless capabilities into the handheld unit. For example, connection to the motor control system could be via 802.11x wifi, Bluetooth, or similar wireless connection means. Alternatively, the connection could be over a cellphone network. Any of these protocols could connect to an app on a smartphone, which could control the parameters or profiles of the motor motion.

The use of wireless programming of the device could allow real-time remote control of the motor motion. In another embodiment, a person could control the motion or programming of the device remotely over the internet. In yet another embodiment, different users could swap favorite motion profiles via social networking applications. It is possible to build a small social networking service or “app store” that allows people to share their favorite motion profiles. This way, casual users who want additional capabilities from the device will be able to try other motion profiles without having to perform their own programming.

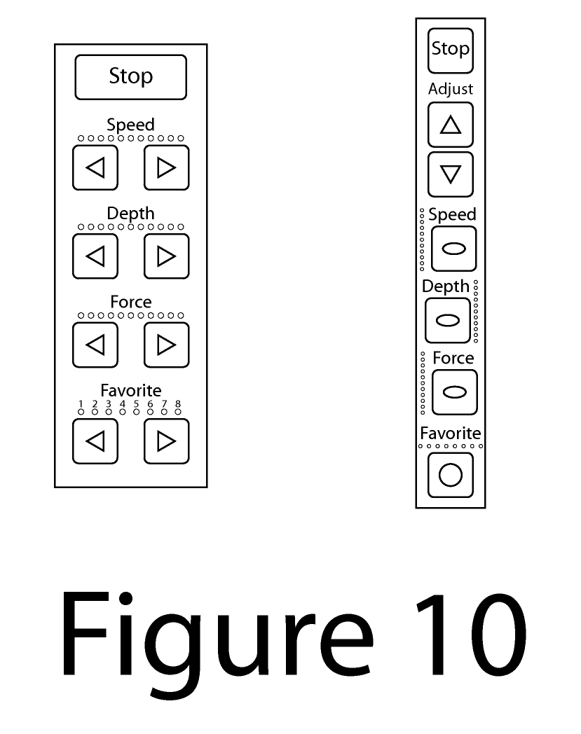

In yet another embodiment, the user interface on the handle of the handheld housing could have several button for changing overall user profiles, and several buttons for control of a few overall parameters of each profile, such as speed. In another example, it is possible to have a few favorite profiles stored in the device, with buttons on the side, or other surface, of the device that allow the user to select a favorite profile, and then possibly more buttons that allow basic manipulation of the profile—perhaps speed and a stroke scaling factor. A scaling factor could simply scale the whole profile, so if the profile had a short-long-short-long series of strokes that were 2″ 4″ 2″ 4″ etc, a 50% scaling would make them 1″ 2″ 1″ 2″. Between that and speed control, complex motion profiles can be easily controlled with just a few buttons. There could also be some “force control” buttons, to limit the maximum force and agressiveness of the motion independent of the speed and profile. A possible embodiment of this type of interface is shown in FIG. 10, where small circles represent indicator LEDs, and rounded rectangles represent buttons. Possible labels are shown above the buttons.

Any combination of the above features and options could be combined into a wide variety of embodiments. It is, therefore, apparent that there is provided in accordance with the present disclosure, systems, and methods for designing, building, and using linear motor, feedback control of motor motion, and integration into electro-mechanical sex toys. While this invention has been described in conjunction with a number of embodiments, it is evident that many alternatives, modifications, and variations would be, or are apparent to, those of ordinary skill in the applicable arts. Accordingly, applicants intend to embrace all such alternatives, modifications, equivalents and variations that are within the spirit and scope of this invention.

I claim:

1. A linear actuator, comprising:
a stator containing more than one coil, wherein said more than one coils are arranged longitudinally along the long axis of said stator,
a mover containing more than one magnet, each said magnet separated from the adjacent magnet by a spacer, wherein said magnets are placed longitudinally along the long axis of said mover, wherein the long axis of said mover is substantially collinear with the long axis of said stator, such that said stator and said mover can move linearly with respect to each other along their long axes,
a power supply operable to provide current to said coils of said stator,
at least one position sensor; and
a controller operable to control the relative motion between said stator and said mover, the controller comprising a module to measure the mover position observed by said position sensor and a module to meter the current sent from said power supply to said coils in response to the position measured by said position sensor.

2. The linear actuator of claim 1, wherein said mover is semi-cylindrical and said stator is split semi-cylindrical, such that the mover is substantially contained within and moves through the interior of said stator, wherein said magnets contained by said mover move through said coils of said stator, and wherein a mounting flange extends from the mover through the split in the stator.

3. The linear actuator of claim 2, wherein said position sensor is a magnetic flux sensor, and wherein said controller is operable to calculate the motion of said mover relative to said stator by measuring the magnetic flux observed by said magnetic flux sensor due to the motion of said magnets in said mover past said magnetic flux sensor, and further operable to use the calculated motion of said mover to meter the current sent from said power supply to said coils to achieve the desired motion of said mover.

4. A method of controlling the motion of a linear actuator, comprising:
supplying current to at least one coil, wherein said at least one coil is arranged along the long axis of a stator,
moving a mover along the long axis of said stator, wherein said mover contains at least one magnet, wherein the magnets move through said at least one coil, wherein the motion of said mover is due to said current through said at least one coil,
measuring a position of said mover observed by at least one position sensor due to said mover position relative to said position sensor; and
metering a current supplied to said at least one coil in response to measuring said position in order to control the relative motion between said stator and said mover to a predetermined state.

5. The method of claim 4, wherein said current is metered to achieve a specific position and speed of said mover relative to said stator.

6. The method of claim 4, wherein said at least one position sensor is at least one magnetic flux sensor, and further comprising the step of:
modulating said current in order to modulate the speed of said mover relative to said stator in response to said magnetic flux measured by said magnetic flux sensor.

7. A sexual appliance, comprising:
a housing,
a linear actuator contained within said housing,
a coupling at least one end of said linear actuator, said coupling configured to attach an ergonomic interface,
a controller to control said linear actuator; and
an interface to supply power to said linear actuator.

8. The sexual appliance of claim 7, further comprising:
a stator within the linear actuator, said stator containing more than one coil, each said coil, wherein said coils are arranged longitudinally along the long axis of said stator,
a mover within the linear actuator, said mover containing more than one magnet, each said magnet separated from the adjacent magnet by a spacer, wherein said magnets are placed longitudinally along the long axis of said mover, wherein the long axis of said mover is substantially collinear with the long axis of said stator, such that said stator and said mover can move linearly with respect to each other along their long axes,
at least one magnetic flux sensor; and
a controller operable to control the relative motion between said stator and said mover, the controller comprising a module to measure magnetic flux observed by said magnetic flux sensor and a module to meter the current sent from said power supply to said coils in response to the magnetic flux measured by said magnetic flux sensor, wherein said controller is operable to calculate the motion of said mover relative to said stator by measuring the magnetic flux observed by said magnetic flux sensor due to the motion of said magnets in said mover past said magnetic flux sensor, and further operable to use the calculated motion of said mover to meter the current sent from said power supply to said coils to achieve the desired motion of said mover.

9. The sexual appliance of claim 7, wherein the housing is designed to be handheld.

10. The sexual appliance of claim 7, wherein said controller is operable to receive commands from a user to modify the motion of said linear actuator.

11. The sexual appliance of claim 10, further comprising:
a electrical connector contained on said housing,
a memory operable to receive and store a linear actuator motion profile from said electrical connector; and
a control module within said controller operable to read said linear actuator motion profile from said memory to apply said linear actuator motion profile to said linear actuator.

12. The sexual appliance of claim 10, further comprising:
a wireless communication circuit contained in said housing,
a memory operable to receive and store a linear actuator motion profile from said wireless communication circuit; and
a control module within said controller operable to read said linear actuator motion profile from said memory to apply said linear actuator motion profile to said linear actuator.

13. The sexual appliance of claim 10, further comprising:
a communication circuit contained in said housing, said communication circuit operable to communicate with a portable electronic device,
a memory operable to receive and store a linear actuator motion profile from said communication circuit; and
a control module within said controller operable to read said linear actuator motion profile from said memory to apply said linear actuator motion profile to said linear actuator.

14. The sexual appliance of claim 10, wherein in said commands include control of the linear actuator speed and stroke.

15. The sexual appliance of claim 10, further comprising:
a wireless communication circuit contained in said housing, said communication circuit operable to communicate with a computer over the internet,
a memory operable to receive and store a linear actuator motion profile from said computer via said wireless communication circuit; and
a control module within said controller operable to read said linear actuator motion profile from said memory to apply said linear actuator motion profile to said linear actuator.

16. The sexual appliance of claim 7, further comprising:
a user input interface on the surface of said housing; and
a control module within said controller operable to receive commands from said user input interface, wherein said commands are used by said controller to control the motion of the linear actuator.

17. The sexual appliance of claim 16, further comprising:
a memory operable to store more than one linear actuator motion control profiles,
a user input control on said user input interface operable to select a linear actuator motion control profile stored in said memory; and
a control module within said controller operable to read the selected linear actuator motion profile from said memory to apply said linear actuator motion profile to said linear actuator.

18. The sexual appliance of claim 7, wherein the linear actuator operates along a curvilinear path.

19. The sexual appliance of claim 7, further comprising a rotary actuator operable to apply rotational motion to said ergonomic interface.

20. The sexual appliance of claim 7, further comprising a second coupling at the second end of said linear actuator, said second coupling configured to attach a second ergonomic interface.
